(19) United States
(12) Patent Application Publication
(10) Pub. No.: US 2024/0116584 A1
(43) Pub. Date: Apr. 11, 2024

(54) AUTOMATED SEMI-TRAILER CONNECTION AND REMOTE CONTROL

(71) Applicant: RTLD Solutions LLC, Miami, FL (US)

(72) Inventors: Ronald Anduray, Miami, FL (US); Diego Silva, West Palm Beach, FL (US)

(21) Appl. No.: 18/482,747

(22) Filed: Oct. 6, 2023

Related U.S. Application Data
(60) Provisional application No. 63/413,811, filed on Oct. 6, 2022.

(51) Int. Cl. B62D 53/12

(52) U.S. Cl. CPC B62D 53/125

(57) ABSTRACT

Systems and methods for controlling a trailer. One example system includes a transceiver and an electronic controller coupled to the trailer and the transceiver. The electronic controller is configured to determine that a tractor has entered an area proximate to the trailer. The electronic controller is configured to determine that the tractor has mechanically coupled to the trailer. The electronic controller is configured to receive, via the transceiver, a command related to a component of the trailer. The electronic controller is configured to operate the component based on the command.

### CROSS-REFERENCE TO RELATED APPLICATIONS

The present application is related to and claims benefit under 35 U.S.C. § 119(e) from U.S. Provisional Patent Application Ser. No. 63/413,811, filed Oct. 6, 2022, entitled “Automated Semi-Trailer Connection and Remote Control,” the entire contents of which is incorporated herein by reference.

### BACKGROUND

Embodiments, examples, and aspects relate to, among other things, systems and methods for automatically connecting to and remotely controlling semi-trailers.

### SUMMARY

Semi-trailers (also referred to herein as “trailers”) are used with semi-tractors to haul cargo of all sorts over the road. As cargo is shipped from its source to its final destination, it is loaded, transferred, stored, and unload at various facility yards (e.g., logistics centers, ports, warehouse terminals, freight yards, hubs, and the like). Operators of facility yards use terminal tractors to move and relocate semi-trailers within their facilities. Such terminal tractors, which are smaller than over the road (“OTR”) semi-tractors, are designed for in-yard use only. When a semi-trailer arrives at a facility yard, the OTR semi-tractor is disconnected from the trailer and a terminal tractor is connected with the trailer to move it about the yard. Likewise, a trailer that has completed its loading/unloading operations and is ready to leave the yard for its journey is disconnected from the terminal tractor and connected to the OTR semi-tractor. Because there are often many more trailers in a yard than there are terminal tractors, a trailer may be disconnected and re-connected from the same or many terminal tractors multiple times while it is in the yard. Using current systems, both the semi-tractor and terminal tractors must physically connect and disconnect three lines from the trailer to couple the trailer's parking brake, service brake, and electrical systems to the controls for those systems on the connecting tractor.

Such connections and disconnections are made manually by a human being, either by the driver of the tractor or by another yard worker. Manual connections take time, increase wear and tear on the components, and may pose injury risks to those making the connections. Robotic arm mechanisms have been proposed to perform the task of connecting and disconnecting from tractors from trailers. However, such mechanisms are costly to manufacture, maintain, and repair. A stationary robotic arm is only able to connect and disconnect trailers at one position, and still requires some manual connections and disconnections for movements within the yard. In addition, damage to such a mechanism results in a reversion to manual connections for all trailers entering and leaving the yard.

To address, among other things, these problems, systems and methods are provided here for automatically virtually connecting tractors to semi-trailers to provide for remote access and control of the trailer braking, electrical, and other systems. Among other things, embodiments provided herein use trailer control systems including electrical (e.g., electronic controllers and relays) and mechanical components (e.g., compressed air sources) integrated into or removably coupled to a trailer to physically interface with the trailer's braking and electrical systems and wirelessly integrate with a portable electronic device to provide remote control of the trailer. Using such embodiments, a tractor operator is able to couple the tractor to a trailer for towing (e.g., via the fifth wheel) and remotely control the braking and lighting systems of the trailer without having to manually connect any hoses or cables between the tractor and the trailer. In some embodiments, the trailer control system is equipped with sensors for automatically detecting fifth wheel engagement (e.g., accelerometers). In some embodiments, autonomous or semi-autonomous terminal trailers are able to hook up to a trailer, move the trailer about the yard, and disconnect from the trailer, all without human intervention.

Using such embodiments, the time, equipment, and wear and tear required to move trailers into, within, and out of a facility yard is reduced. This results in more efficient use of equipment, reduced costs, and increases in safety. For example, field testing has shown a 33% minimum reduction in hook up and disconnect times when a driver has worked less than 1 hour (i.e., 0% driver fatigue), a 50% minimum reduction in hook up and disconnect times when driver has worked more than 1 but less than 4 hours (i.e., 50% driver fatigue), and a 75% minimum reduction in hook up and disconnect times when driver has worked more than 4 but less than 8 hours (i.e., 75% driver fatigue). In addition, the embodiments presented herein reduce human error by reducing human involvement in the trailer connection process. This, in turn, leads to reduced injury rates. Reduced human involvement also reduces driver fatigue, resulting in fewer accidents and injuries. Additionally, poor weather conditions (e.g., ice, snow, rain, extreme heat or cold, and the like), can contribute to driver injury or discomfort. Systems and methods presented herein mitigate the effects of weather conditions on drivers and tractor/trailer operations.

Trailers, and thus their cargo, are tracked currently by tracking the tractors that haul them. While tractors include geolocation systems and computing devices to transmit telemetry to fleet management operations systems, trailers do not. To address, among other things, this problem, in some embodiments, the trailer control system is equipped to connect with a management and integration system to provide telemetry data (e.g., from sensors, other trailer systems, or GNSS as described herein) on the trailer to an owner, a fleet operator, or other interested parties. In some embodiments the trailer control system includes sensors for sensing aspects of the environment in and around the trailer (e.g., accelerometers, temperature sensors, humidity sensors, LIDAR sensors, RADAR sensors, and the like). In some embodiments, the trailer control system also connects with other trailer systems or devices (e.g., cameras, trailer door switches, tire pressure monitoring systems, and the like). In some embodiments, the trailer control system includes an integrated GNSS (global navigation satellite system) for determining the location of the trailer. Using such embodiments, an operator of the trailer is able to collect data on the whereabouts and other conditions of the trailer (and thus the cargo within) independent of a tractor.

In some aspects, the techniques described herein relate to a system for controlling a trailer, the system including: a transceiver; an electronic controller coupled to the trailer and the transceiver, and configured to: determine that a tractor has entered an area proximate to the trailer; determine that the tractor has mechanically coupled to the trailer; receive, via the transceiver, a command related to a component of the trailer; and operate the component based on the command.

In some aspects, the techniques described herein relate to a control system, further including: a sensor positioned on the trailer; wherein the sensor is coupled to the electronic controller and the electronic controller is further configured to: determine that a tractor has entered the area proximate to the trailer by receiving a signal from the sensor.

In some aspects, the techniques described herein relate to a control system, wherein the electronic controller is configured to: determine that a tractor has entered the area proximate to the trailer by receiving a command signal via the transceiver.

In some aspects, the techniques described herein relate to a control system, further including: a sensor positioned on the trailer for sensing conditions associated with a kingpin of the trailer; wherein the sensor is coupled to the electronic controller and the electronic controller is configured to: determine that the tractor has mechanically coupled to the trailer by receiving a signal from the sensor and determining that the signal indicates a coupling of the kingpin of the trailer to a fifth wheel of the tractor.

In some aspects, the techniques described herein relate to a control system, wherein the electronic controller is configured to determine that the signal indicates the coupling of the kingpin of the trailer to the fifth wheel of the tractor by: detecting a fifth wheel jerk motion; and detecting a drag of a landing gear of the trailer.

In some aspects, the techniques described herein relate to a control system, further including: a geolocation system for the trailer coupled to the electronic controller; and a trailer lighting system coupled to the electronic controller; wherein the electronic controller is further configured to: responsive to determining that the tractor has mechanically coupled to the trailer, control the geolocation system to active geolocation services for the trailer; and activate the trailer lighting system.

In some aspects, the techniques described herein relate to a control system, wherein the component is one selected from the group consisting of a parking brake, a service brake, a light, an air compressor, a camera, a tire pressure monitoring system, a lift gate motor, a trailer door switch, and a landing gear motor.

In some aspects, the techniques described herein relate to a control system, wherein the electronic controller is configured to: prior to receiving the command related to the component of the trailer, transmit, via the transceiver, a unique identifier for the trailer.

In some aspects, the techniques described herein relate to a control system, wherein the only mechanical connection between the tractor and the trailer is by a hitching system.

In some aspects, the techniques described herein relate to a control system, wherein the electronic controller is coupled to a controllable air supply for actuating one or both of an emergency brake system of the trailer and a service brake system of the trailer.

In some aspects, the techniques described herein relate to a control system, wherein the electronic controller is communicatively coupled to a remote server and configured to: transmit, via the transceiver, to the remote server telematics for the trailer; and receive, via the transceiver, from the remote server, control commands for the trailer.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1A is a block diagram illustrating one example of a semi-tractor/trailer system in accordance with some embodiments.

FIG. 1B is a block diagram illustrating one example of a system for remote control of a semi-tractor/trailer system in accordance with some embodiments.

FIG. 2A is a schematic diagram illustrating a device structure of an electronic communications device of the system of FIG. 1B in accordance with some embodiments.

FIG. 2B is a schematic diagram illustrating a device structure of a server of the system of FIG. 1B in accordance with some embodiments.

FIG. 3A is a schematic diagram illustrating an integrated trailer control system of the system of FIG. 1B in accordance with some embodiments.

FIG. 3B is a schematic diagram illustrating a standalone trailer control system of the system of FIG. 1B in accordance with some embodiments.

FIG. 4 is a schematic diagram illustrating am air pressure system of the trailer control system of FIG. 1B in accordance with some embodiments.

FIG. 5 illustrates a flow chart of a method implemented by the controller of the system for wireless in-yard operation of one or more systems of a trailer in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

For ease of description, some or all of the example systems presented herein are illustrated with a single exemplar of each of its component parts. Some examples may not describe or illustrate all components of the systems. Other embodiments may include more or fewer of each of the illustrated components, may combine some components, or may include additional or alternative components.

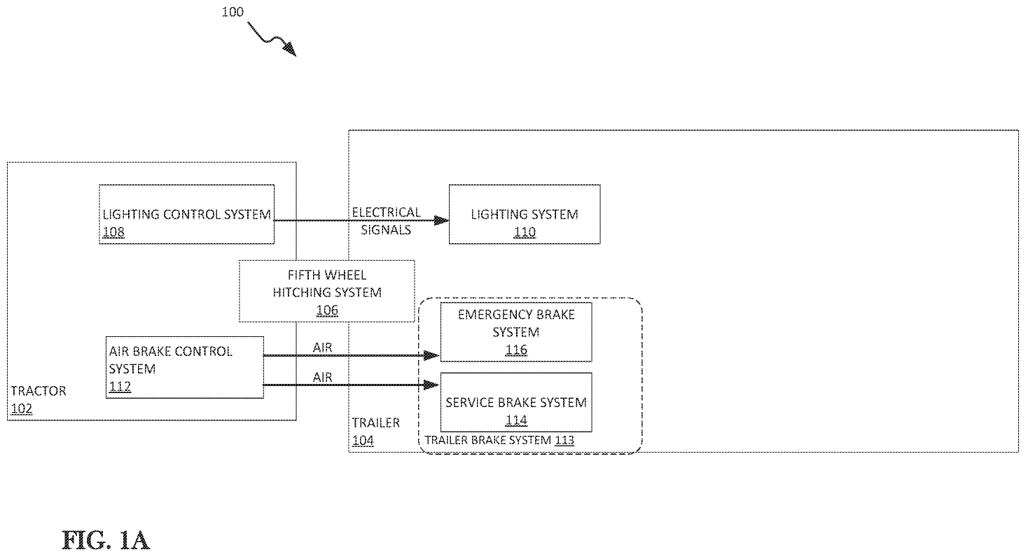

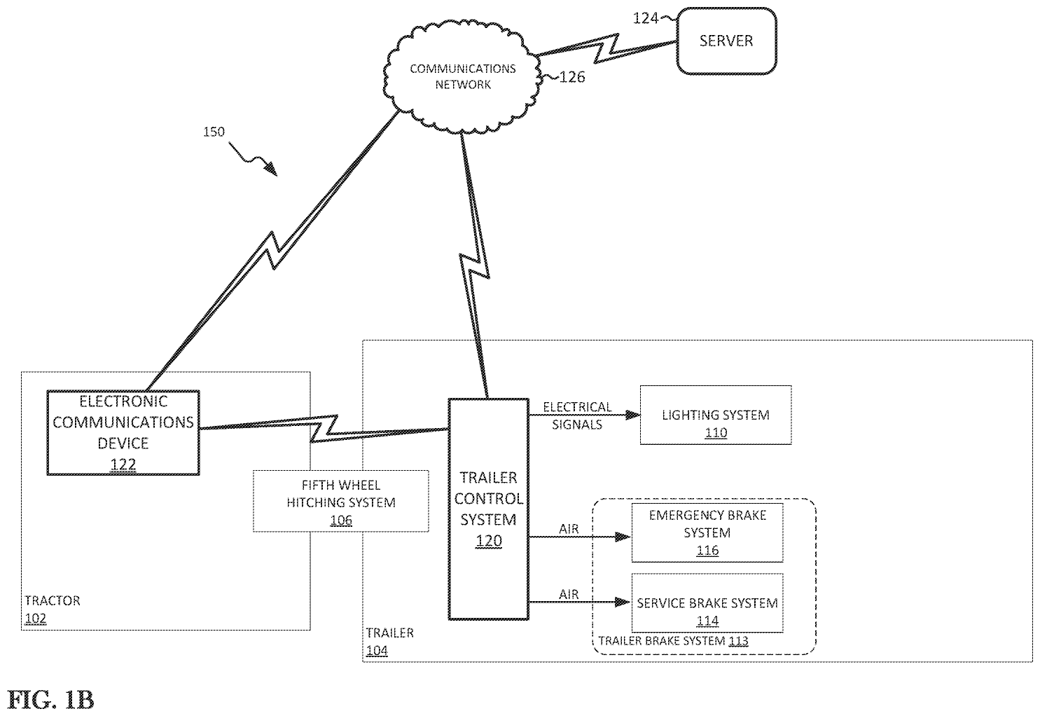

FIG. 1A illustrates one example of a semi-tractor/trailer system 100. The system 100 includes a tractor 102 and a trailer 104. In some aspects, the tractor 102 is a conventional, non-autonomous terminal trailer. In some aspects, the tractor 102 and trailer 104 may be a conventional semi-tractor/trailer combination (e.g., a Class 7 or Class 8 truck). In some examples, the tractor 102 is an autonomous terminal tractor, which may be a partially autonomous vehicle or a fully autonomous vehicle, either of which may possess varying degrees of automation (that is, the vehicle is configured to drive itself with limited, or in some cases no, input from a driver). The systems and methods described herein may be used with any tractor capable of operating partially or fully autonomously, being controlled manually by a driver, or some combination of both. In should also be noted that the term “driver,” as used herein, generally refers to an occupant of a vehicle, autonomous vehicle, or semi-autonomous vehicle, who is seated in the driver's position, operates the controls of the vehicle while in a manual mode, or provides control input to the vehicle to influence the autonomous or semi-autonomous operation of the vehicle.

As illustrated in FIG. 1A, the tractor 102 and the trailer 104 are configured to be interconnected removably via a hitching system 106. In one embodiment, the hitching system 106 includes a “fifth” wheel of the trailer 104 and a kingpin of the trailer 104. The kingpin is positioned along the bottom front of the trailer 104. The fifth wheel of the trailer 104 includes a pad and a receiving slot for the kingpin. When connected, the kingpin rides in the slot of the fifth wheel such that the trailer 104 may axially pivot with respect to the tractor 102 as the tractor 102 is driven to pull the trailer 104.

The tractor 102 includes, among other things, a lighting control system 108 and an air brake control system 112, which include components for controlling the trailer lighting system 110 and the trailer brake system 113, respectively, of the trailer. Such control systems are known and need not be described herein.

The trailer 104 includes a trailer lighting system 110, which includes various lights for providing visibility and signaling while the trailer is at rest or in motion. The trailer also includes a trailer brake system 113, which comprises a service brake system 114 and an emergency (or parking) brake system 116.

One or more removable connections (e.g., via one or more air lines and one or more electrical connection lines, which are not shown) may be made between the tractor 102 and trailer 104 (for example, by connecting the respective connection lines of the tractor 102 to one or more respective connection inputs of the trailer 104) to deliver both electric power and air pressure to the trailer lighting system 110 and the trailer brake system 113. The air pressure provided by the tractor 102 is used to operate the service brake system 114 and the emergency brake system 116 (e.g., in conjunction with the lighting control system 108 and the air brake control system 112) of the trailer 104. The electrical power provided by the tractor 102 is used to power components of the trailer lighting system 110 of the trailer, for example, interior lighting, exterior signal and running lights, and the like. In some embodiments, the electrical coupling between the tractor 102 and the trailer 104 may be used to operate lift gate motors, landing gear motors, and the like.

FIG. 1B illustrates a system 150 for automatically connecting to and remotely controlling the trailer 104. The system 150 includes a trailer control system 120, an electronic communications device 122, and a server 124.

As illustrated in FIG. 1B, the trailer control system 120, electronic communications device 122, and server 124 are communicatively coupled by a communications network 126. The communications network 126 is a communications network including wireless connections, wired connections, or combinations of both. The communications network 126 may be implemented using a wide area network, for example, the Internet (including public and private IP networks), a cellular network (e.g., a Long Term Evolution (LTE) network, a 4G network, 5G network), one or more local area networks (e.g., a Bluetooth™ network or Wi-Fi™ network), and combinations or derivatives thereof. As further illustrated in FIG. 1B, the trailer control system 120 and the electronic communications device 122 may communicate directly, for example, via a Bluetooth™, Wi-Fi™, or another suitable near distance wireless protocol.

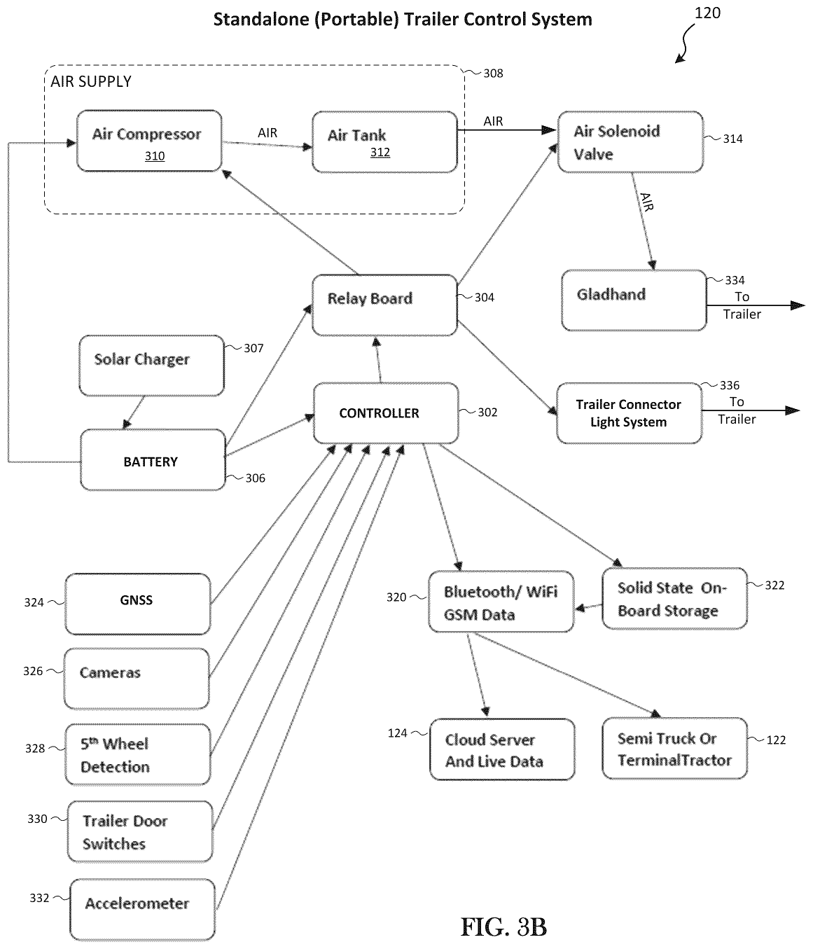

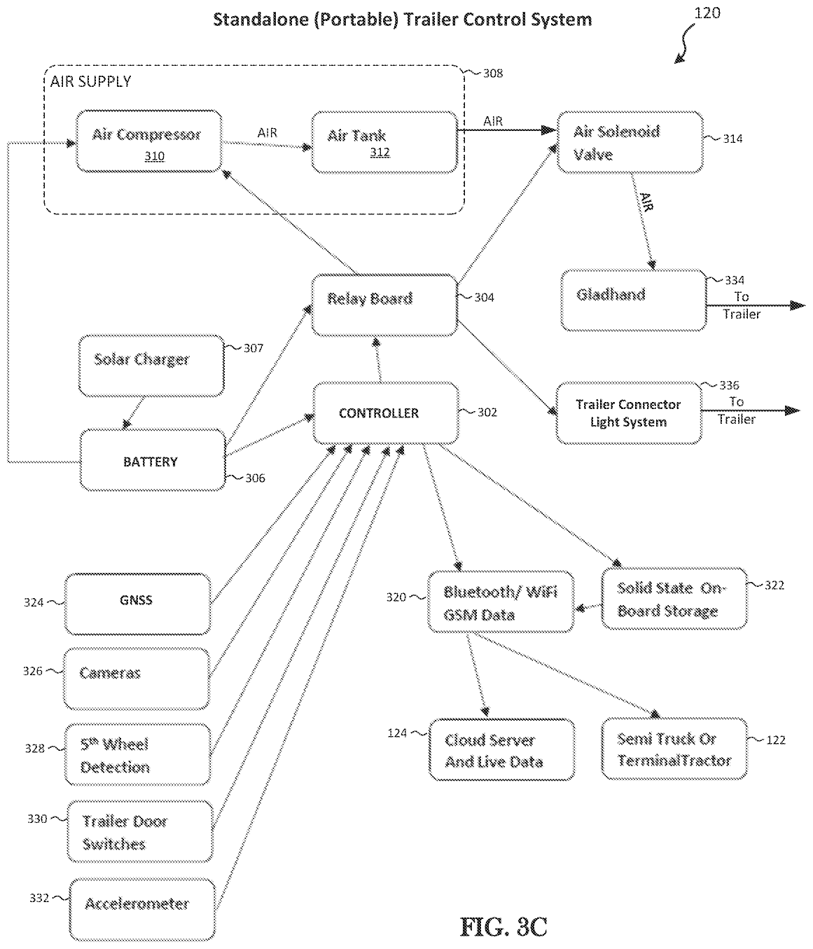

The trailer control system 120, described more particularly with respect to FIGS. 3A and 3B, is configured to interface with the trailer lighting system 110 and the trailer brake system 113. As described herein, the trailer control system 120 interfaces directly with the trailer's systems such that the tractor 102 and the electronic communications device 122 may operate the trailer 104 without the need for the removable connections described above with respect to FIG. 1A.

The trailer control system 120 includes a controllable air supply 308 for actuating the emergency brake system 116, the service brake system 114, or both. The trailer control system 120 includes suitable control circuits and relays for controlling the trailer lighting system 110 and other electrical systems of the trailer 104.

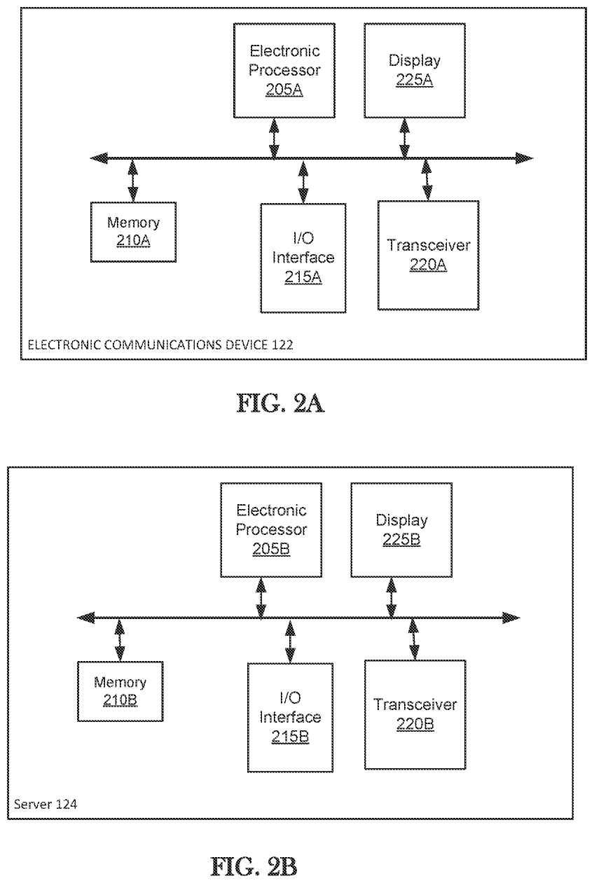

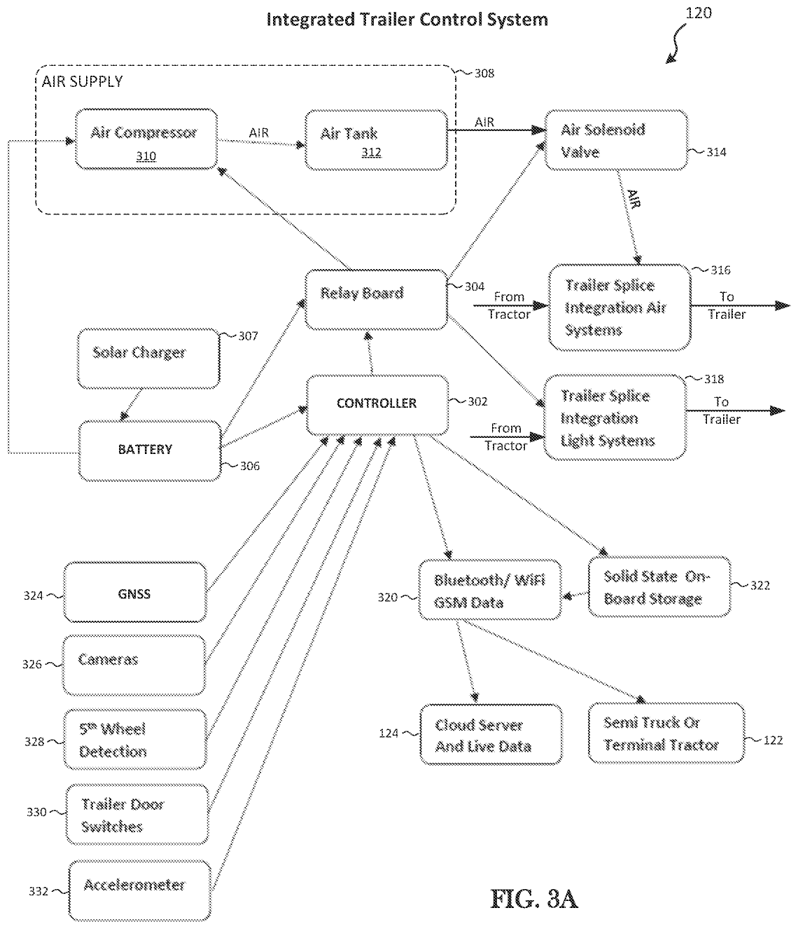

The electronic communications device 122, described more particularly with respect to FIG. 2A, issues commands to the trailer control system, which in turn controls the trailer systems accordingly. In some embodiments, the electronic communications device 122 is a self-contained portable device (e.g., a tablet computer). In some embodiments, the electronic communications device 122 is integrated into the control systems of the tractor 102 (e.g., as part of a human machine interface, an infotainment system, or another vehicle control system).

In some embodiments, the server 124, described more particularly with respect to FIG. 2B, receives data, for example, telematics data regarding the trailer 104, from the trailer control system 120. In some embodiments, the server 124 includes or is coupled to an electronic database (e.g., stored in a memory of the server 124 or implemented as cloud-based system and accessible by the server 124 over one or more intervening networks).

FIG. 2A illustrates a block system diagram of the electronic communications device 122 according to some embodiments. The electronic communications device 122 includes an electronic processor 205A, a memory 210A, and an input/output interface 215A. In some embodiments, the controller 115A also includes one or more of a transceiver 220A, and/or a display 230A. The illustrated components, along with other various modules and components are coupled to each other by or through one or more control or data buses that enable communication therebetween. The use of control and data buses for the interconnection between and exchange of information among the various modules and components would be apparent to a person skilled in the art in view of the description provided herein.

The electronic processor 205A obtains and provides information (for example, from the memory 210A and/or the input/output interface 215A) and processes the information by executing one or more software instructions or modules, capable of being stored, for example, in a random access memory (“RAM”) area of the memory 210A or a read only memory (“ROM”) of the memory 210A or another non-transitory computer readable medium (not shown). The software can include firmware, one or more applications, program data, filters, rules, one or more program modules, and other executable instructions. The electronic processor 205A is configured to retrieve from the memory 210A and execute, among other things, software related to the control of the trailer 104, as described herein.

The memory 210A can include one or more non-transitory computer-readable media and includes a program storage area and a data storage area. The program storage area and the data storage area can include combinations of different types of memory, as described herein.

The input/output interface 215A is configured to receive input and to provide system output. The input/output interface 215A obtains information and signals from, and provides information and signals to, (for example, over one or more wired and/or wireless connections) devices both internal and external to the electronic communications device 122. For example, the input/output interface 215A exchanges data with one or more of the tractor 102, the trailer control system 120, and the server 124 via the transceiver 220A.

The electronic processor 205A is configured to control the transceiver 220A to transmit and receive data to and from the electronic communications device 122. The processor 205A encodes and decodes digital data sent and received by the transceiver 220A. The transceiver 220A transmits and receives radio signals to and from, for example, one or more remote electronic devices (for example, the server 124). Some embodiments include separate transmitting and receiving components, for example, a transmitter and a receiver, instead of a combined transceiver 220A.

As mentioned above, in some embodiments, the electronic communications device 122 includes a display 230A. The display 230A is a suitable display such as, for example, a liquid crystal display (LCD) touch screen, or an organic light-emitting diode (OLED) touch screen. The electronic communications device 122 implements a graphical user interface (GUI) (for example, generated by the electronic processor 205A, from instructions and data stored in the memory 210A, and presented on the display 230A), that enables a user to interact with the electronic communications device 122.

The electronic processor 205A, the memory 210A, the input/output interface 215A, the transceiver 220A, the sensors 225A, and the display 230A may include various digital and analog components, which for brevity are not described herein and which may be implemented in hardware, software, or a combination of both.

FIG. 2B illustrates a system block diagram of the server 124 according to some embodiments. The server 124 includes electrical components configured similar to those of the electronic communications device 122. For example, the server 124 includes an electronic processor 205B, a memory 210B, and an input/output interface 215B. The server 124 includes a transceiver 220B and/or a display 225B. The illustrated components, along with other various modules and components are coupled to each other by or through one or more control or data buses that enable communication therebetween. The use of control and data buses for the interconnection between and exchange of information among the various modules and components would be apparent to a person skilled in the art in view of the description provided herein. The electronic processor 205B, the memory 210B, the input/output interface 215B, the transceiver 220B, and the display 225B are configured and function similar to the respective components described above regarding FIG. 2A and, for sake of brevity, are not further described herein.

In some embodiments, the server 124 operates fleet platform software, which provides for telematics, AVL, fleet management, and other functions. For example, the server 124 may store and analyze data received from the trailer control system 120. Such data may include geolocation data, current speed, average speed, trip mileage, total mileage, crash detection, brake detection, acceleration detection, motion detection (theft detection), door open/closed status, 5^{th} wheel coupling detection, video streams from trailer attached cameras (interior or exterior), air brake leak detection, air pressure detection, and brake light malfunction detection. The server 124 may track and/or provide to an operator of the trailer, for example, via the electronic communications device 122 or another suitable means, information regarding service intervals, service history, trailer contents and inventory, and destination. The server 124 may also be able to remotely activate lights and other aspects of the trailer systems.

FIG. 3A illustrates one example embodiment of the trailer control system 120. In the example illustrated, the trailer control system 120 is integrated into the trailer 104. For example, the components described may be contained in a housing mounted in or on the trailer.

The system 120 includes a controller 302 (e.g., an electronic controller). In some embodiments, the controller 302 is a single board computer including an electronic processor, a memory, and an I/O, in addition to other components. The controller 302 is coupled to a relay board, which includes relays for triggering lighting, solenoids, valves, and the like, as described herein. The controller and other components of the system 120 are powered by a battery 306 (e.g., a 12V battery), which is rechargeable (e.g., by the solar charger 307). The battery 306 powers, and the controller 302 controls (via the relay board 304) an air supply 308. The air supply 308 includes an air compressor 310 for generating compressed air, which is stored in the air tank 312.

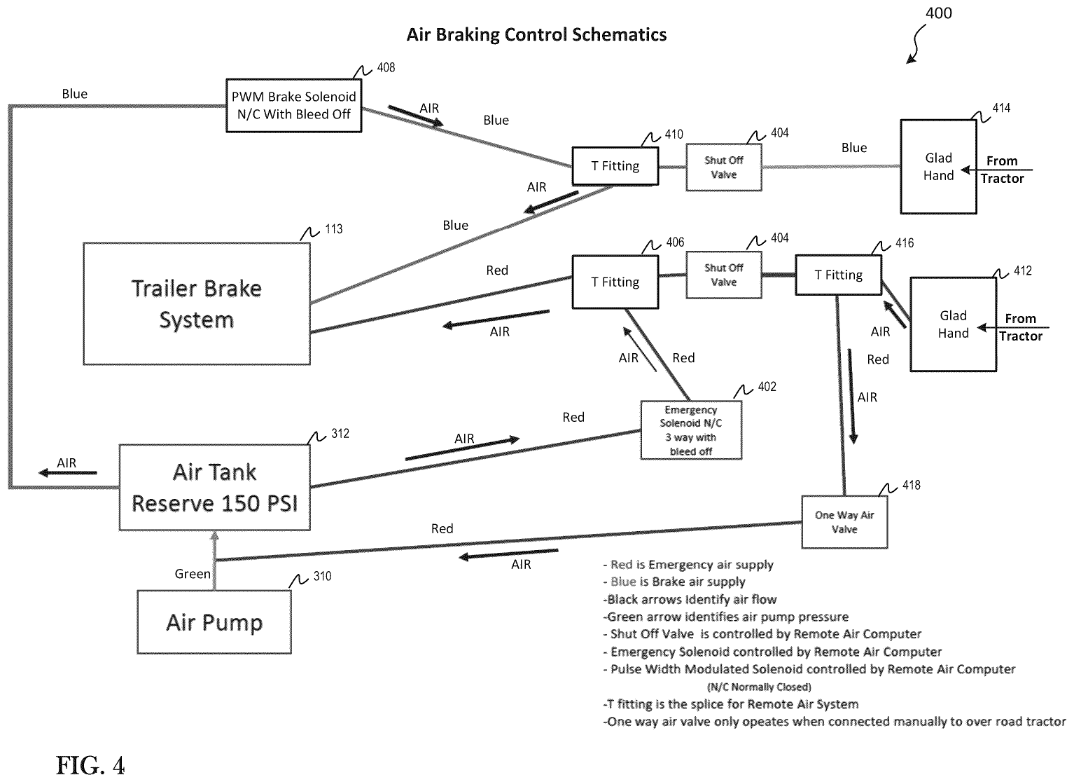

The controller 302 (e.g., responsive to commands received from the electronic communications device 122) selectively controls the air solenoid valve 314 to provide air pressure to the trailer brake system. As described with respect to FIG. 4, the air pressure may be used to release the parking brakes or to control the service brakes of the trailer 104. As illustrated in FIG. 3A, the pressurized air flows through a splice 316. The splice 316 provides air to the trailer brake system 113 when a tractor air supply is not connected and allows the tractor air supply to flow directly through to the trailer brake system 113 when the tractor air supply is connected.

The controller 302 (e.g., responsive to commands received from the electronic communications device 122) controls the relay board 304 to operate the trailer lighting system 110. As with the air brakes, the lighting controls are connected through a splice 318, which can disconnect the relay board 304 when the electrical connection from the tractor 102 is present, to allow the tractor 102 to control the trailer electrical systems (e.g., the trailer lighting system 110) directly.

As noted, the controller 302 may gather telemetry and other data about the trailer 104. For example, the trailer control system 120, as illustrated, includes a GNSS (global navigation satellite system) for geolocating the trailer 104. The controller 302 may also receive inputs from cameras 326, fifth wheel detection sensors 328, trailer door switches 330, and an accelerometer 332. The trailer control system 120 may also include one or more other sensors configured to monitor one or more characteristics within an area surrounding the trailer 104 and/or within the trailer 104. The sensors may include, but are not limited to, one or more of an image sensor, speed/acceleration sensor, temperature sensor, distance sensor, humidity sensor, temperature sensor, LIDAR, RADAR, and the like. The sensors may also be configured to measure one or more characteristics of one or more systems of the controller 302 and/or trailer 104 (e.g., of the trailer lighting system 110 and/or the air brake system 113).

Data collected from these systems and sensors may be transmitted live to the sever 124, the electronic communications device 122, or elsewhere via a network interface (e.g., the interface 320). In some embodiments, the data is first stored locally (e.g., in a solid-state memory 322).

FIG. 3B illustrates another example embodiment of the trailer control system 120. In the example illustrated, the trailer control system 120 is not integrated into the trailer 104. For example, the components described may be contained in a portable housing, which is removably mounted on a trailer when it enters a yard. The embodiment illustrated in FIG. 3B includes similar components and operates similarly to the embodiment described with respect to FIG. 3A. However, rather than providing a bypass, the air and electrical connections are direct. The air solenoid valve 314 connects to a gladhand 334, which is connected to an air brake input on the trailer 104. Similarly, the relay board connects to a trailer connector 336, which plugs into an electrical connector (for example, a standard 7 pin connector) of the trailer 104. When the trailer is ready to be taken over the road, the connection lines are disconnected, and the tractor's connection lines are connected. While the portable unit still requires a manual connect and disconnect, it need only be done once upon entry to a facility yard and once upon departing the yard. While operating in the yard, no other manual intervention is required.

FIG. 4 is a schematic diagram illustrating an air bypass system 400 of the trailer control system 120 according to some embodiments. It should be noted that some or all of the components of the system 400 may be integrated into the trailer 104.

As illustrated in FIG. 4, the air compressor 310 provides compressed air to the air tank 312. When the trailer 104 is being controlled remotely, and no air lines are connected from the trailer, the controller 302 (e.g., via the relay board 304) opens the emergency solenoid 402 and closes the shut off valves 404. This allows air to flow through the T fitting 406 to pressurize the emergency brake system 116 of the trailer brake system 113. In some embodiments, the trailer control system 120 allows for remote control of the service brake system 114 via PWM control of the brake solenoid 408, which allows air to flow through the T fitting 410 to operate the service brake system 114 of the trailer brake system 113.

When air lines are connected from the tractor 102 to the glad hands 412, 414, the controller 302 closes the solenoids 402, 408 and opens the shut off valves 404. This allows air to flow through the T fitting 416, the shut off valve 404, and the T fitting 406 to pressurize the emergency brake system 116 of the trailer brake system 113. Air also flows through the shut off valve 404 and the T fitting 410 to operate the service brake system 114 of the trailer brake system 113. Air also flows from the T fitting 416 through the one-way valve 418 to keep the air tank 312 full. In the event that the lines are disconnected, this results in a ready supply of air to begin operating.

The coupling of the controller 302 to the trailer brake system 113 also enables leak detection. It is possible for leaks to develop in the trailer brake system 113. Such leaks may not prevent the brakes from operating, but may contribute to increased wear and tear on the trailer brake system 113 (e.g., a leak may result in the compressor running more frequently or valves actuating more often than when the system is operating without leaks). In addition, a leak which is not addressed may eventually lead to a sudden pressure drop or complete failure of the trailer brake system 113. To address this, in some embodiments, the electronic controller 302 is configured to detect and report leak conditions in the trailer brake system 113. For example, the trailer control system 120 may include one or more pressure sensors configured to sense air pressure in the trailer brake system 113 over time. The electronic controller 302 may detect leaks by analyzing sensor readings received from the one or more pressure sensors, and report detected leaks to the server 124, to a driver via the device 122, or using another suitable means.

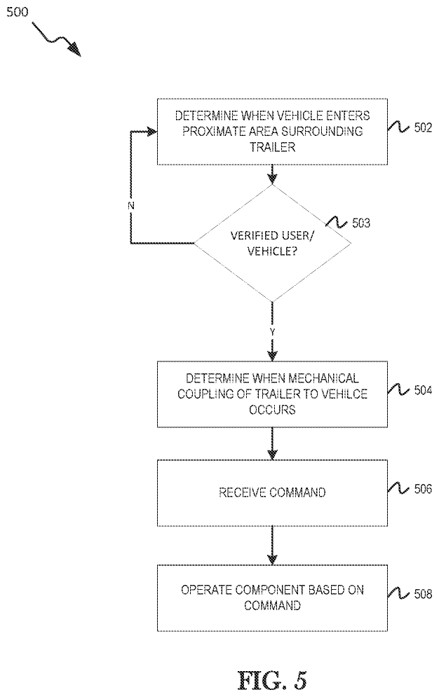

FIG. 5 is a flowchart illustrating a method 500 of wireless remote in-yard operation of one or more systems (e.g., the trailer lighting system 110 and/or the air brake system 113) of a trailer (e.g., the trailer 104) according to some embodiments. The method 500 may be modified or performed differently than the specific example provided. As an example, the method 500 is described as being performed by the trailer control system 120 and, in particular, the controller 302. However, it should be understood that in some instances, portions of the method 500 may be performed by other devices or subsystems of the system 100.

At block 502, the controller 302 determines when a tractor 102 enters an area surrounding (e.g., proximate to) the trailer 104. The area may be, in some embodiments, a predefined area (e.g., approximately five to twenty feet from the trailer 110). The controller 302 may utilize one or more sensors (e.g., a camera, a lidar sensor, a radar sensor, and the like) in order to detect when the tractor 102 enters the area. Additionally, or alternatively, the controller 302 may detect the trailer 104 in response to a command signal from a remote system (for example, from the electronic communications device 122 or the server 124) indicating that the trailer 104 is within the predetermined area. The signal may be sent automatically or generated via a user of the remote system. For example, the signal may be sent automatically by the system upon determining that the trailer 104 has entered the area. In some embodiments, the trailer control system 120 may determine that the trailer 104 has entered the area based on additional information such as global positioning system data regarding the location of the trailer 104.

At block 504, the controller 302 determines a mechanical coupling of the trailer 104 to the trailer 104. In particular, the controller 302 detects a coupling of the kingpin of the trailer 104 to the fifth wheel of the tractor 102. The controller 302 may determine the coupling via information from one or more sensors (for example, an accelerometer, a proximity sensor, a lidar sensor, etc.). In some embodiments, the controller 302 analyzes signals from an accelerometer to detect a fifth wheel jerk motion, indicating an initial hitch. Upon detecting the jerk motion, the controller 302 analyzes signals from the accelerometer to detect a drag of the landing gear of the trailer 104. When such a drag is detected the controller 302 releases the parking brakes of the trailer 104, activates geolocation services for the trailer, and activates the trailer lighting system 110.

At block 506, the controller 302 receives a command (e.g., from the electronic communications device 122) and operates a component of the trailer 104 based on the received command. For example, the controller 302 may release an emergency/parking brake of the trailer 104, as noted above. As another example, the controller 302 may operate one or more lights of the trailer 104 based on the command.

In some embodiments, the controller 302, between blocks 504 and 506, is configured to verify an identity of the trailer 104 (or a user of the trailer 104 thereof) based on information received from either or both of the electronic communications device 122 and the server 124. For example, the controller 302 may receive from the device 122 or the server 124 a unique identifier of the trailer 104 (e.g., a vehicle identification number) or of the operator of the trailer 104 (e.g., an employee identifier. The controller 302 may then determine, based on the unique identifier, whether the tractor 102 or user thereof is authorized to couple the trailer 104 to the tractor 102. If the controller 302 determines that the trailer 104/user is authorized, the controller 302 proceeds to block 506. Otherwise, the controller 302 ignores command signals received that are associated with the trailer 104. For example, if the controller 302 may ignore a command signal to release an emergency/parking brake of the trailer 104.

In some embodiments, the controller 302, between blocks 504 and 506, is configured to check for and report leaks in the trailer brake system 113. If the controller 302 determines that there are no leaks, the controller 302 proceeds to block 506. If the controller 302 detects a leak, it may halt further operations and issue an alert reporting the leak.

The controller 302 may further be configured to detect when the tractor 102 is mechanically decoupled from the trailer 104 and/or when the tractor 102 is no longer within an area proximate to the trailer 104. The controller 302 may determine the decoupling using a method similar to that described above in regard to block 504 and 502 respectively.

As described above, controller 302, via the method 500, allows for control of the trailer lighting system 110 and/or air brake system 113 of the trailer 104 without the need to mechanically connect the tractor 102 to those systems. The method 500 thus may provide for faster transport of trailers within a yard or facility, where trailers may be moved across numerous times a day.

In addition to the features described above, the controller 302 may be configured to be utilized in on-road applications (for example, when the trailer 104 is to be transported on public roads). In on-road applications, it may be necessary for systems of the tractor 102 (for example, a commercial motorized vehicle) to be coupled to their respective systems of the trailer 104 (e.g., in order to comply with one or more federal, state, or local commercial transport regulations). In such instances, the controller 302 may be mechanically configured to transfer control of such systems from itself to the tractor, granting the tractor direct control.

In the foregoing specification, specific embodiments are described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way but may also be configured in ways that are not listed.

The terms “coupled,” “coupling,” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

Various features and advantages of the embodiments and examples presented herein are set forth in the following claims.

What is claimed is:

1. A system for controlling a trailer, the system comprising:
a transceiver;
an electronic controller coupled to the trailer and the transceiver, and configured to:
determine that a tractor has entered an area proximate to the trailer;
determine that the tractor has mechanically coupled to the trailer;
receive, via the transceiver, a command related to a component of the trailer; and
operate the component based on the command.

2. The control system of claim 1, further comprising:
a sensor positioned on the trailer;
wherein the sensor is coupled to the electronic controller and the electronic controller is further configured to:
determine that a tractor has entered the area proximate to the trailer by receiving a signal from the sensor.

3. The control system of claim 1, wherein the electronic controller is configured to:
determine that a tractor has entered the area proximate to the trailer by receiving a command signal via the transceiver.

4. The control system of claim 1, further comprising:
a sensor positioned on the trailer for sensing conditions associated with a kingpin of the trailer;
wherein the sensor is coupled to the electronic controller and the electronic controller is configured to:
determine that the tractor has mechanically coupled to the trailer by receiving a signal from the sensor and determining that the signal indicates a coupling of the kingpin of the trailer to a fifth wheel of the tractor.

5. The control system of claim 4, wherein the electronic controller is configured to determine that the signal indicates the coupling of the kingpin of the trailer to the fifth wheel of the tractor by:
detecting a fifth wheel jerk motion; and
detecting a drag of a landing gear of the trailer.

6. The control system of claim 1, further comprising:
a geolocation system for the trailer coupled to the electronic controller; and
a trailer lighting system coupled to the electronic controller;
wherein the electronic controller is further configured to:
responsive to determining that the tractor has mechanically coupled to the trailer, control the geolocation system to active geolocation services for the trailer; and
activate the trailer lighting system.

7. The control system of claim 1, wherein the component is one selected from the group consisting of a parking brake, a service brake, a light, an air compressor, a camera, a tire pressure monitoring system, a lift gate motor, a trailer door switch, and a landing gear motor.

8. The control system of claim 1, wherein the electronic controller is configured to:
prior to receiving the command related to the component of the trailer, transmit, via the transceiver, a unique identifier for the trailer.

9. The control system of claim 1, wherein the only mechanical connection between the tractor and the trailer is by a hitching system.

10. The control system of claim 1, wherein the electronic controller is coupled to a controllable air supply for actuating one or both of an emergency brake system of the trailer and a service brake system of the trailer.

11. The control system of claim 1, wherein the electronic controller is communicatively coupled to a remote server and configured to:
transmit, via the transceiver, to the remote server telematics for the trailer; and
receive, via the transceiver, from the remote server, control commands for the trailer.
